(19) United States
(12) Patent Application Publication
(10) Pub. No.: US 2022/0043505 A1
(43) Pub. Date: Feb. 10, 2022

(54) BEHAVIOR DATA PROCESSING SYSTEM

(71) Applicant: Intelove Technologies Company Limited, Tainan City (TW)

(72) Inventor: WEI-KAI CHUNG, Tainan City (TW)

(21) Appl. No.: 16/984,188

(22) Filed: Aug. 4, 2020

(51) Int. Cl. G06F 3/01; G02B 27/01; G06T 13/40; G06T 13/20; G06F 3/16

(52) U.S. Cl. CPC G06F 3/011; G02B 27/0172; G02B 27/0179; G02B 2027/0187; G06T 13/205; G06F 3/167; G06T 13/40

(57) ABSTRACT

A behavior data processing system includes a sensor, an interaction detector, and a VR head mounted device. The sensor is wore on a user for sensing the positional variation track of the user for generating a motion behavior signal. The interaction detector is disposed on a body model. The interaction detector, according to the interaction relationship between the user and the body model, identifies an interaction behavior signal. The VR head mounted device, according to the motion behavior signal sensed by the sensor and the interaction behavior signal detected by the interaction detector, accurately simulates the interaction relationship between the user and the virtual character, so as to increase the realistic experience of the simulation.

### BACKGROUND OF THE INVENTION

### 1. Field of the Invention

The present invention relates to VR processing techniques, and more particularly, to a behavior data processing system.

### 2. Description of the Related Art

In a fast-pacing modern life, many people spend most of their time on working. In free time, people usually interact with other people through social media and software on electronic devices. Although being capable of providing functions of text and voice interaction, social software are unable to provide a real-life experience, so that the interest of social interaction is lowered.

Recently, with rapid development of virtual techniques, such as VR (virtual reality), AR (augmented reality), and MR (mixed reality), users may carry out social interaction simulation with virtual characters. However, for VR experience, VR equipment are only able to identify simple identification upon behaviors and actions of the user, by which the exact behaviors of the user are easily misidentified. As a result, the realness of social interaction simulation is lowered.

### SUMMARY OF THE INVENTION

For improving the issues above, a behavior data processing system is disclosed, which increases the realistic experience of social interaction simulation.

For achieving the aforementioned objectives, a behavior data processing system is provided, comprising a sensor, an interaction detector, and a VR head mounted device. The sensor is wore by a user for sensing the variation track of the position of the user for generating a motion behavior signal. The interaction detector is disposed on a body model for identifying an interaction behavior signal according to the interaction relationship between the user and the body model. The VR head mounted device is coupled with the sensor and the interaction detector. The VR head mounted device comprises a virtual interaction database, a VR module, an image display module, and a signal processing module. The virtual interaction database stores a plurality of virtual interaction data, and comprises a virtual character corresponding to the body model. The VR module acquires the virtual interaction data from the virtual interaction database, and displays the virtual interaction data through the image display module. The user is able to watch the virtual character in a virtual social field. The signal processing module conducts a virtual interaction simulation with the virtual character at least according to the motion behavior signal and the interaction behavior signal.

With such configuration, the sensor accurately acquires the body motion variations, and the interaction detector is able to detect the status of the user contacting the bod model, such that the VR head mounted device, according to the motion behavior signal detected by the sensor and the interaction behavior signal detected by the interaction detector, accurately simulates the interaction between the user and the virtual character, thereby improving the realistic experience of social simulations and achieving an immersive experience.

### BRIEF DESCRIPTION OF THE DRAWINGS

FIG. 1 is a structural block view of the system in accordance with an embodiment of the present invention.

FIG. 2 is a structural block view illustrating the sensor in accordance with an embodiment of the present invention.

FIG. 3 is a structural block view illustrating the interaction detector in accordance with an embodiment of the present invention.

FIG. 4 is a structural block view illustrating the VR head mounted device in accordance with an embodiment of the present invention.

FIG. 5 is another structural block view of the VR head mounted device in accordance with a preferred embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

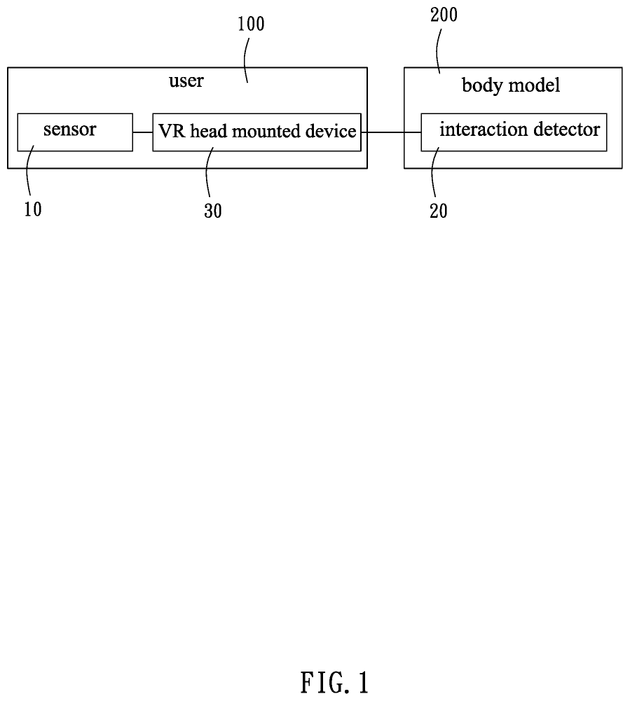

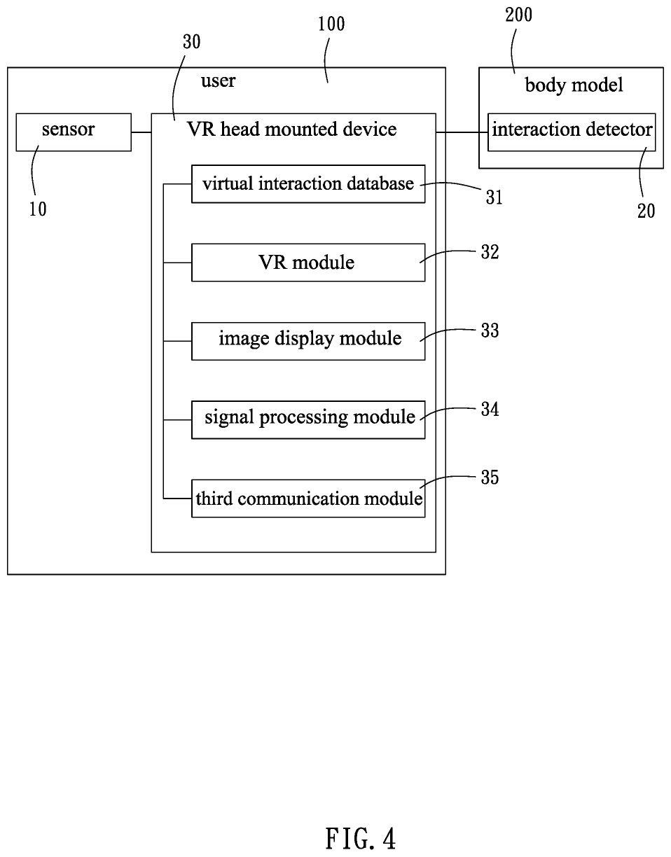

Referring to FIG. 1 to FIG. 5, a behavior data processing system in accordance with an embodiment of the present invention comprises a sensor 10, an interaction detector 20, and a VR (virtual reality) head mounted device 30.

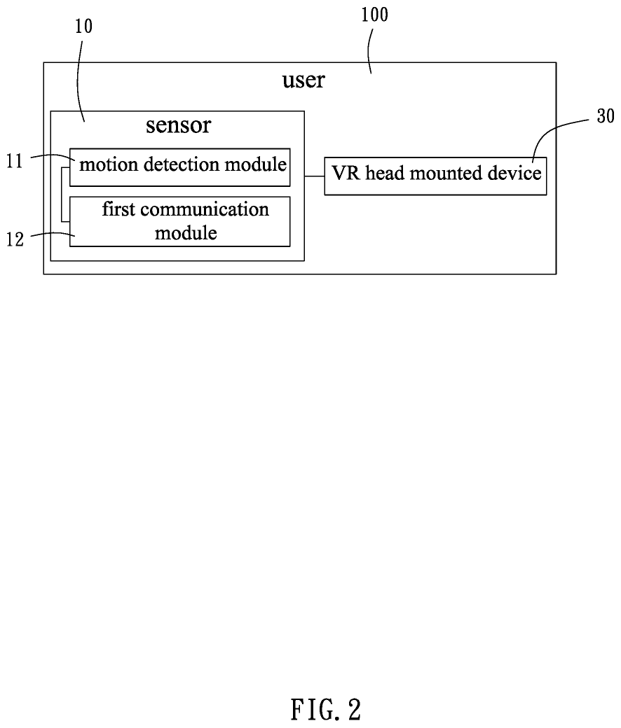

The sensor 10 is wore on the user 100 for sensing the position variation track of the user 100 for generating a motion behavior signal. In a preferred embodiment, the sensor 10 is selected from a group consisting of a speedometer, gyroscope, barometer, magnetometer, electronic compass, and heart rate monitor. Also, the sensor 10 is wore on the waist, chest, and the back of the user 100 for sensing the pose, direction, angle, movement, heart rate, and speed of the user 100. Referring to FIG. 1 and FIG. 2, the sensor 10 comprises a motion detection module 11 and a first communication module 12. The motion detection module 11 identifies the variation track of the position of the user 100 according to the variation of the pose, direction, angle, movement, and speed of the user 100, so as to generate the motion behavior signal. The first communication module 12 is applied for transmitting the motion behavior signal.

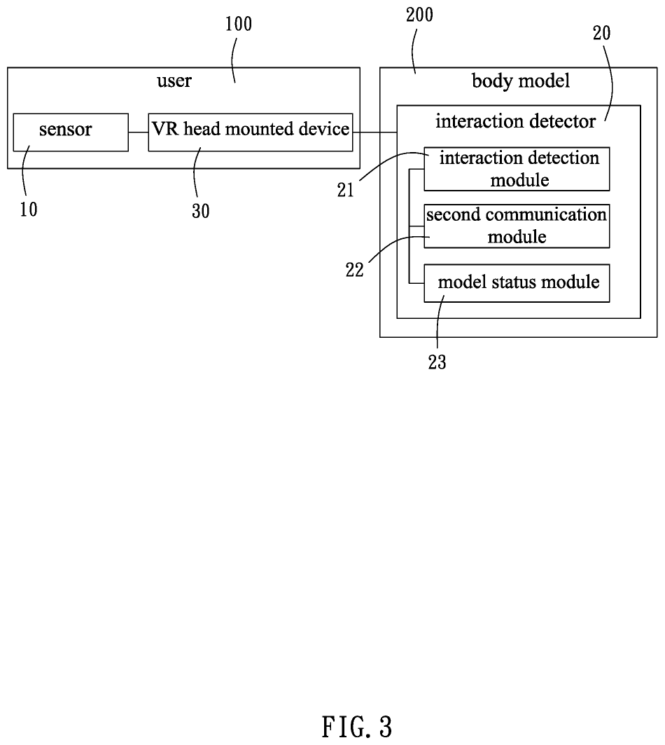

The interaction detector 20 is disposed on a body model 200 for detecting a plurality of motions of the user 100 contacting the body model 200, so as to identify an interaction behavior signal. In a preferred embodiment, the body model 200 is a human figure. The interaction detector 20 is a pressure detector, temperature detector, or a moisture detector. Referring to FIG. 1 and FIG. 3, the interaction detector 20 comprises an interaction detection module 21 and a second communication module 22. The interaction detection module 21, according to the pressurization position, variations of pressure, temperature, and moisture, identifies an interaction behavior signal. The second communication module 2 is applied for transmitting the interaction behavior signal.

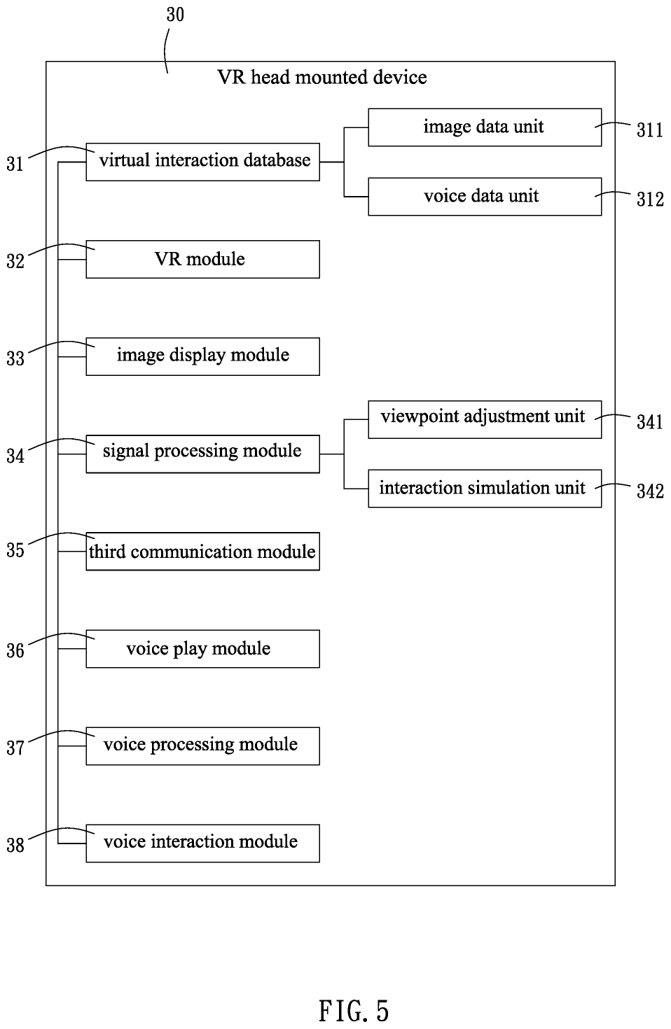

The VR head mounted device 30 is wore on the head of the user 100 and coupled with the sensor 10 and the interaction detector 20. The VR head mounted device 30 comprises a virtual interaction database 21, a VR module 32, an image display module 33, and a signal processing module 34. The virtual interaction database 31 stores a plurality of virtual interaction data, which comprise a virtual character corresponding to the body model 200. In a preferred embodiment, referring to FIG. 5, the virtual interaction database 31 comprises an image data unit 311 and a voice data unit 312. The image data unit 311 is applied for storing virtual interaction data, and the voice data unit 312 is applied for storing a plurality of interaction voice data.

The VR module 32 acquires the virtual interaction data from the virtual interaction database 31 and displays the virtual interaction data through the image display module 33. The user 100 is able to watch the virtual character during a virtual social field. The signal processing module 34, at least according to the motion behavior signal and the interaction behavior signal, conducts interaction simulation with the virtual character. Referring to FIG. 5, the signal processing module 34 in the embodiment comprises a viewpoint adjustment unit 341 and an interaction simulation unit 342. The viewpoint adjustment unit 341, according to the motion behavior signal, adjusts the viewpoint and the distance of the user 100 watching the virtual character. The interaction simulation unit 342, according to the interaction behavior signal, identifies the body positions of the virtual character virtually touched by the user 100. In other words, when the user 100 contacts the body model 200, the interaction simulation unit 342 correspondingly presents the body positions touched by the virtual character.

In a preferred embodiment, referring to FIG. 2 to FIG. 5, the VR head mounted device 30 comprises a third communication module 35 and a voice play module 36. The third communication module 35 is coupled with the first communication module 12 of the sensor 10 and the second communication module 22 of the interaction detector 20. Therein, the connection method between the third communication module 35 and the first communication module 12 and the second communication module 22 includes but is not limited to RFID (radio frequency identification) and Bluetooth. The third communication module 35 is applied for receiving the motion behavior signal transmitted by the first communication module 12 and the interaction behavior signal transmitted by the second communication module 22.

The voice play module 36 is applied for playing the interaction voice data outputted by the voice data unit 312. When the VR head mounted device 30 receives the interaction behavior signal triggered by the interaction detector 20, the interaction simulation unit 342 of the signal processing module 34, according to the interaction behavior signal, acquires the corresponding interaction voice data from the voice data unit 312 and plays the interaction voice data through the voice play module 36. Therefore, the user 100 contacts the body model 200 to triggers the sound play, achieving a realistic interaction experience.

Notably, the interaction detector 20 further comprises a model status module 23 for identifying the general profile and the current position of the body model 200, so as to generate a body status information, which is transmitted through the second communication module 22 to the third communication module 35. The VR module 32 is able to present the virtual character according to the model status information. Therefore, the user 100 is able to acquire the current position and pose status of the virtual character in a virtual social field, thereby increasing the observation simulation accuracy.

Therefore, the sensor 10 accurately acquires the body variation of the user 100, and the interaction detector 20 is able to detect the status of the user 100 contacting the body model 200, such that the VR head mounted device 30, according to the behavior signal sensed by the sensor 10 and the interaction behavior signal detected by the interaction detector 20, thereby accurately simulating the interaction relationship between the user 100 and the virtual character. Thus, the user 100 feels a realistic interaction or contact, improving the realistic feeling of the social simulation and achieving an immersive experience. In a preferred embodiment, referring to FIG. 5, the VR head mounted device 30 further comprises a sound processing module 37 and a voice interaction module 38.

The sound processing module 37 receives a target voice emitted by the user 100 and process the target voice into a voice signal. The voice interaction module 38 receives the voice signal from the voice processing module 37, and, according to the voice signal, acquires the corresponding interaction voice data from the voice data unit 312 of the interaction database 31, so as to play the interaction voice data through the voice play module 36. Therefore, the present invention further provides a sound feedback, so that the user 100 is able to acquire a seemingly true conversation interaction with the virtual character, whereby the interest of social simulation is improved.

With the foregoing configuration, objectives of the present invention will be illustrated below.

With the detection assistance of the sensor 10 and the interaction detector 20, the VR head mounted device 30 accurately simulates the interaction relationship between the user 100 and the virtual character, so as to improve the realistic experience of the social simulation and achieves an immersive experience.

The present invention provides the feedback of image and sound, so that the user 100 acquires a seemingly true interaction with virtual character, such that the interest of social simulation is improved.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A data processing system, comprising:
a sensor wore by a user for sensing a variation tracks of positions of the user for generating a motion behavior signal; the sensor comprising a motion detection module and a first communication module; the motion detection module identifying the variation track of the positions of the user according to variations selected from a group consisting of a pose, direction, angle, movement, and speed of the user, and accordingly generating the motion behavior signal; the first communication module being applied for transmitting the motion behavior signal;
an interaction detector disposed on a body model for detecting a plurality of motions of the user contacting the body model and identifying an interaction behavior signal according to the motions; the interaction detector comprising an interaction detection module and a second communication module; the interaction detection module, according to a pressurization position, variations of pressure, temperature, and moisture generated by the user touching the body model, identifying the interaction behavior signal; the second communication module being applied for transmitting the interaction behavior signal; and
a VR head mounted device coupled with the sensor and the interaction detector, the VR head mounted device comprising a virtual interaction database, a VR module, an image display module, a signal processing module, and a third communication module; the virtual interaction database storing a plurality of virtual interaction data, the virtual interaction data comprising a virtual character corresponding to the body model; the VR module acquiring the virtual interaction data from the virtual interaction database, and displaying the virtual interaction data through the image display module, such that the user watches the virtual character in a virtual social field; the signal processing module conducting an interaction simulation with the virtual character at least according to the motion behavior signal and the interaction behavior signal; the third communication module being coupled with the first communication module and the second communication module; the third communication module being applied for receiving the motion behavior signal transmitted by the first communication module and the interaction behavior signal transmitted by the second communication module; the signal processing module comprising a viewpoint adjustment unit and an interaction simulation unit; the viewpoint adjustment unit, according to the motion behavior signal, adjusting a viewpoint and a distance of the user watching the virtual character; the interaction simulation unit, according to the interaction behavior signal, identifying body positions of the virtual character virtually contacted by the user.

2. (canceled)

3. The data processing system of claim 1, wherein the sensor is selected from a group consisting of a speedometer, gyroscope, barometer, magnetometer, electronic compass, and heart rate monitor.

4. (canceled)

5. The data processing system of claim 1, wherein the interaction detector is selected from a group consisting of a pressure detector, temperature detector, and a moisture detector.

6. (canceled)

7. The data processing system of claim 1, wherein the interaction detector further comprises a model status module for identifying a general profile and a current position of the body model, so as to generate a body status information, which is transmitted through the second communication module to the third communication module; the VR module presents the virtual character according to the model status information.

8. (canceled)

9. The data processing system of claim 1, wherein the virtual interaction database comprises an image data unit and a voice data unit; the image data unit is applied for storing virtual interaction data, and the voice data unit is applied for storing a plurality of interaction voice data; the interaction simulation unit, accordingly to the interaction behavior signal, acquires the corresponding interaction voice data from the voice data unit; the VR head mounted device further comprises a voice play module for playing the interaction voice data.

10. The data processing system of claim 9, wherein the VR head mounted device further comprises a sound processing module and a voice interaction module; the sound processing module receives a target voice emitted by the user and processes the target voice into a voice signal; the voice interaction module, according to the voice signal, acquires the corresponding interaction voice data from the voice data unit, so as to play the interaction voice data through the voice play module.
